(19) United States
(12) Patent Application Publication
(10) Pub. No.: US 2021/0090050 A1
(43) Pub. Date: Mar. 25, 2021

(54) CHECKOUT SYSTEM

(71) Applicant: TOSHIBA TEC KABUSHIKI KAISHA, Tokyo (JP)

(72) Inventor: Tatsuya KANEKO, Mishima Shizuoka (JP)

(73) Assignee: TOSHIBA TEC KABUSHIKI KAISHA, Tokyo (JP)

(21) Appl. No.: 16/918,110

(22) Filed: Jul. 1, 2020

(30) Foreign Application Priority Data
Sep. 20, 2019 (JP) 2019-171944

(51) Int. Cl. G06Q 20/20; G06Q 20/32; G06Q 30/06

(52) U.S. Cl. CPC G06Q 20/202; G06Q 30/0633; G06Q 20/3276

(57) ABSTRACT

A checkout system includes a mobile terminal configured to acquire a commodity code for identifying a commodity. The checkout system further includes a controller configured to acquire a first amount indicating an amount payable by an electronic settlement procedure and display, on a display, a first screen for determining whether settlement is performed through the electronic settlement based on whether the first amount is equal to or greater than a second amount, which is a total amount of the commodity based on the commodity code.

### CROSS-REFERENCE TO RELATED APPLICATION

This application is based upon and claims the benefit of priority from Japanese Patent Application No. 2019-171944, filed in Sep. 20, 2019, the entire contents of which are incorporated herein by reference.

### FIELD

Embodiments described herein relate generally to a checkout system.

### BACKGROUND

In recent years, a cart POS (Point Of Sales) system has been proposed for retail stores equipped with shopping carts. In such a cart POS system, an information terminal including a touch panel and a scanner is provided in the shopping cart. A user of the shopping cart, who is a customer, causes, if placing a commodity that the user is about to purchase (so called purchased commodity on the shopping cart), the scanner to read an identification code of the purchased commodity and performs commodity registration. In this way, in the cart POS system, the user himself or herself performs the commodity registration while doing shopping. Therefore, congestion in an accounting place, a so-called register can be reduced.

Related art is described in, for example, JP-A-2017-102934.

### DESCRIPTION OF THE DRAWINGS

FIG. 1 is an overall configuration diagram of a cart POS system functioning as a checkout system according to an embodiment;

FIG. 2 is a schematic diagram illustrating a main data structure of a commodity database;

FIG. 3 is a block diagram illustrating a main part circuit configuration of a mobile controller;

FIG. 4 is a schematic diagram illustrating a main data structure of a VPOS table of the mobile controller;

FIG. 5 is a schematic diagram illustrating a main data structure of a shopping basket memory of the mobile controller;

FIG. 6 is a block diagram illustrating a main circuit configuration of an information terminal;

FIG. 7 is a schematic diagram illustrating a main data structure of a main memory of the information terminal;

FIG. 8 is a schematic diagram illustrating an overview of software configuration and operation of the mobile controller;

FIG. 9A is a diagram illustrating a first portion of a sequence chart illustrating an overview of an overall operation of the cart POS system;

FIG. 9B is a diagram illustrating a second portion of the sequence chart illustrating the overview of the overall operation of the cart POS system;

FIG. 10A is a diagram illustrating a first portion of a flowchart illustrating a procedure of main information processing executed by a processor of the information terminal according to a terminal program;

FIG. 10B is a diagram illustrating a second portion of the flowchart illustrating the procedure of the main information processing executed by the processor of the information terminal according to the terminal program;

FIG. 11 is a flowchart illustrating a procedure of main information processing of a POS server operation executed by a processor of the mobile controller according to a POS server program;

FIG. 12 is a flowchart illustrating a procedure of main information processing of a VPOS operation executed by the processor of the mobile controller according to a VPOS program;

FIG. 13 is a schematic diagram illustrating an example of display of a login screen in the information terminal;

FIG. 14 is a schematic diagram illustrating an example of display of a commodity registration screen in the information terminal;

FIG. 15 is a schematic diagram illustrating an example of warning display in the information terminal;

FIG. 16 is a schematic diagram illustrating an example of display of a first accounting selection screen in the information terminal;

FIG. 17 is a schematic diagram illustrating an example of display of a payment completion screen in the information terminal; and

FIG. 18 is a schematic diagram illustrating an example of display of a second accounting selection screen in the information terminal.

### DETAILED DESCRIPTION

An object of embodiments is to provide a checkout system in which settlement can be performed by a cart POS.

In an embodiment, a checkout system includes a mobile terminal configured to acquire a commodity code for identifying a commodity. The checkout system further includes a controller configured to acquire a first amount indicating an amount payable by an electronic settlement procedure and display, on a display, a first screen for determining whether settlement is performed through the electronic settlement based on whether the first amount is equal to or greater than a second amount, which is a total amount of the commodity based on the commodity code.

An embodiment of a checkout system is explained below with reference to the drawings. The embodiment explained below is applied to a cart POS system.

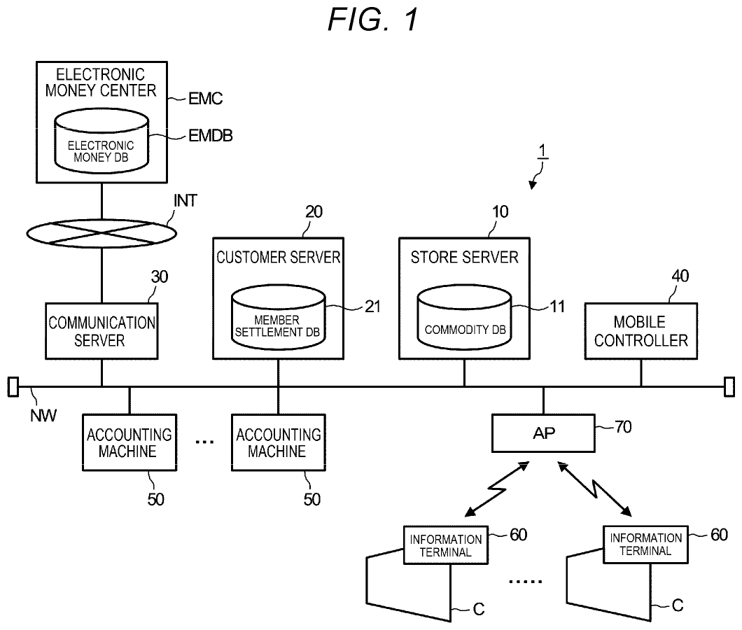

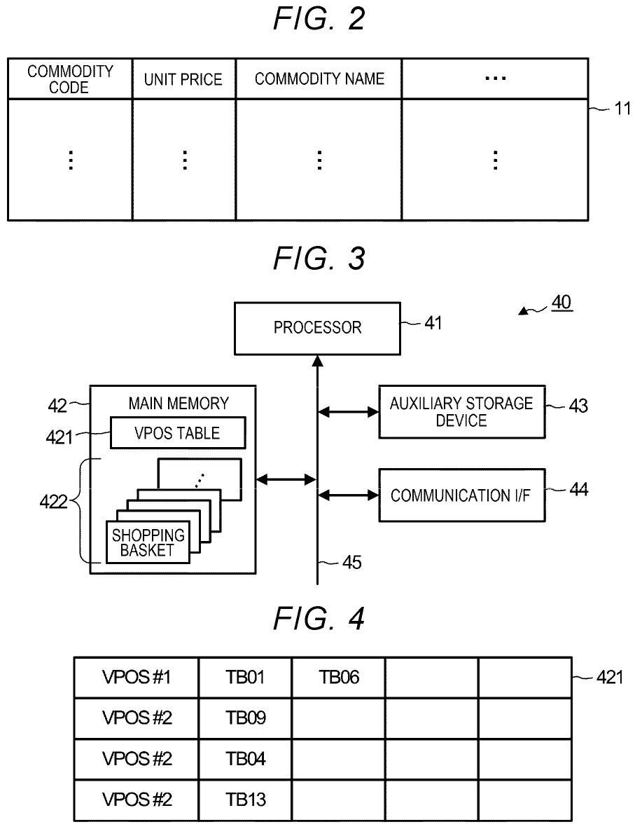

FIG. 1 is an overall configuration diagram of a cart POS system 1 functioning as a checkout system according to the embodiment. The cart POS system 1 includes a store server 10, a customer server 20, a communication server 30, a mobile controller 40, an accounting machine 50, a plurality of information terminals 60, and an access point (illustrated as AP in FIG. 1) 70. The store server 10, the customer server 20, the communication server 30, the mobile controller 40, the accounting machine 50, and the access point 70 are connected to a network NW such as a LAN (Local Area Network) or a wireless LAN.

The information terminal 60 is a device that enables a customer, who is a purchaser, to input data relating to registration of purchased commodities by himself or herself. The information terminal 60 is provided in a shopping cart C. The shopping cart C is referred to as cart C in the following explanation. The information terminals 60 are respectively provided in a plurality of carts C. The cart C is an example of a carrier that carries purchased commodities of a customer, who can be a user of the cart C.

The information terminal 60 is provided in the cart C. The information terminal 60 is an information processing terminal functioning as a user interface for operation relating to registration of purchased commodities. The information terminal 60 includes a wireless unit. The information terminal 60 performs wireless communication with the access point 70. The access point 70 relays communication between the devices connected to the network NW, that is, the store server 10, the customer server 20, the communication server 30, the mobile controller 40, and the accounting machine 50 and the information terminals 60. Only one access point 70 is illustrated in FIG. 1. However, two or more access points 70 may be provided according to the size and the like of a store.

The accounting machine 50 is a device that enables a store clerk or a customer to perform accounting of purchased commodities. The accounting machine 50 can be a self-service POS terminal. The accounting machine 50 may be a facing-type POS terminal. The number of accounting machines 50 is not particularly limited.

The store server 10 supports a store job. For the support, the store server 10 manages a commodity database (DB) 11, a sales database, and the like. The commodity database 11 saves, for each of commodities for sale in the store, a commodity record describing commodity data. The commodity record includes a commodity code, a price, and a commodity name. The commodity code is an identification code of the commodity. The sales database saves a sales record describing sales data for each of items such as a commodity, a department, a time period, a date, a week, and a month. The sales data includes the number of sold items and a sales amount.

The customer server 20 supports a purchase job of a customer having member registration, a so-called member. For the support, the customer server 20 manages a member database, a member settlement database 21, and the like. The member database saves a member record describing member data for each of members. The member data (or member identifier) includes a member number, a name, sex, a mail address, and the like. The member number is an identification code of the member. The member settlement database 21 saves, for each of the members, a member settlement record describing data for payment of a price. The member settlement record includes, besides the member number, an electronic money identification code and an electronic money user ID as data for payment of a price. In this embodiment, a price payment method for the member to pay a price without using the accounting machine 50 is limited to only one type, that is, electronic money. The electronic money identification code is an identification code of electronic money registered beforehand as electronic money used for payment by the member identified by the member number. The electronic money user ID is an identification code for an electronic money center EMC to identify a user of the electronic money and is given by the electronic money center EMC. In order to enable payment by the electronic money, the member registers the electronic money identification code and the electronic money ID beforehand in member registration or the like. If the prior registration for the electronic money is not performed, NULL or 0000 is stored in the electronic money identification code and the electronic money ID of the accounting settlement record.

The communication server 30 supports data communication processing performed between the accounting machine 50 or the mobile controller 40 and the electronic money center EMC via a network INT such as the Internet or an electronic money dedicated network.

The electronic money center EMC supports settlement by electronic money. For the support, the electronic money center EMC manages an electronic money database (DB) EMDB. The electronic money database EMDB gives, for each of registered users of the electronic money, an electronic money user ID and saves an electronic money record describing data relating to the electronic money. The electronic money record includes an electronic money identification code and a charge balance as the data relating to the electronic money. The electronic money identification code is an identification code of the electronic money used by the registered user of the electronic money. The charge balance is a balance of a charge amount of the electronic money specified by the electronic money identification code corresponding to the charge balance.

The mobile controller 40 cooperates with the information terminal 60 to perform support for showing as if the information terminal 60 is functioning as a POS terminal.

FIG. 3 is a block diagram illustrating a main part circuit configuration of the mobile controller 40. The mobile controller 40 includes a processor 41, a main memory 42, an auxiliary storage device 43, a communication interface (I/F) 44, and a system transmission line 45. The system transmission line 45 includes an address bus, a data bus, and a control signal line. In the mobile controller 40, the processor 41, the main memory 42, the auxiliary storage device 43, and the communication interface 44 are connected to the system transmission line 45. In the mobile controller 40, a computer is configured by the processor 41, the main memory 42, and the auxiliary storage device 43 and the system transmission line 45 that connects the forgoing.

The processor 41 is equivalent to a central part of the computer. The processor 41 controls the units in order to realize various functions of the mobile controller 40 according to an operating system or application programs. The processor 41 is, for example, a CPU (Central Processing Unit).

The main memory 42 is equivalent to amain storage portion of the computer. The main memory 42 includes a nonvolatile memory region and a volatile memory region. The main memory 42 stores the operating system or the application programs in the nonvolatile memory region. The main memory 42 sometimes stores, in the nonvolatile or volatile memory region, data necessary for the processor 41 to execute processing for controlling the units. The main memory 42 uses the volatile memory region as a work area in which data is rewritten as appropriate by the processor 41. The nonvolatile memory region is, for example, a ROM (Read Only Memory). The volatile memory region is, for example, a RAM (Random Access Memory).

The auxiliary storage device 43 is equivalent to an auxiliary storage portion of the computer. For example, an EEPROM (Electric Erasable Programmable Read-Only Memory), a HDD (Hard Disc Drive), or an SSD (Solid State Drive) can be the auxiliary storage device 43. The auxiliary storage device 43 saves data used by the processor 41 in performing various kinds of processing, data created by the processing in the processor 41, or the like. The auxiliary storage device 43 sometimes stores the application programs.

The communication interface 44 is connected to the network NW. The communication interface 44 performs data communication according to a communication program between the communication interface 44 and other devices connected via the network NW.

In the mobile controller 40 having such a configuration, a part of the volatile memory region of the main memory 42 is used as creation regions for a VPOS table 421 and a shopping basket memory 422. The mobile controller 40 can create a plurality of shopping basket memories 422 in these regions.

FIG. 4 is a schematic diagram illustrating an example of the VPOS table 421. As illustrated in FIG. 4, the VPOS table 421 can store four terminal numbers for each of four virtual POSs (a VPOS #1 to a VPOS #4). As explained below, the virtual POS is a functional unit realized by the processor 41. The terminal number is an identification code for specifying the information terminal 60.

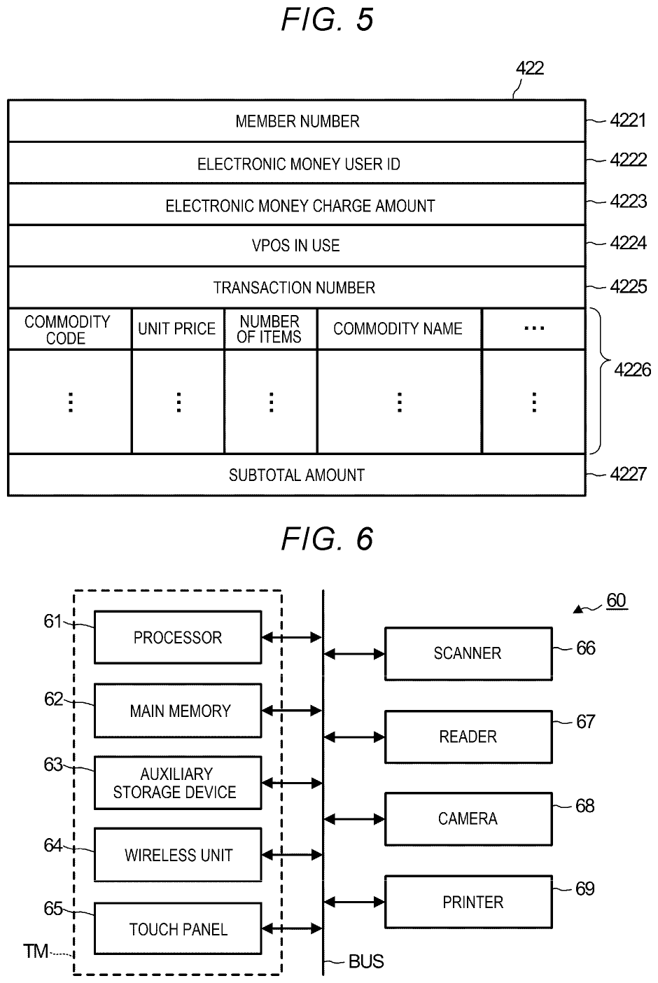

FIG. 5 is a schematic diagram illustrating an example of the shopping basket memory 422. As illustrated in FIG. 5, the shopping basket memory 422 includes a member number region 4221, an electronic money user ID region 4222, an electronic money charge amount region 4223, a VPOS-in-use region 4224, a transaction number region 4225, one or a plurality of purchased commodity data regions 4226, and a subtotal amount region 4227.

In the member number region 4221, a member number for uniquely identifying a customer having member registration, a so-called member and a terminal number of the information terminal 60 used by the member are stored. In the electronic money user ID region 4222, an electronic money user ID allocated to a registered user of electronic money and an electronic money identification code used by the registered user of the electronic money are stored. The electronic money user ID and the electronic money identification code is acquired from the member settlement database 21 of the customer server 20. In the electronic money charge amount region 4223, a charge balance of the electronic money of the customer acquired from the electronic money center EMC is stored. If an electronic money ID is not registered in a settlement record of the member in the accounting settlement database 21, NULL or 0000 is stored in the electronic money user ID region 4222. Since the charge balance of the electronic money of the customer cannot be acquired from the electronic money center EMC, NULL is stored in the electronic money charge amount region 4223 as well.

In the VPOS-in-use region 4224, a VPOS number for uniquely identifying a virtual POS that uses the shopping basket memory 422 is stored. In the transaction number region 4225, a transaction number for uniquely identifying the shopping basket memory 422 is stored. Every time the customer registers, with the information terminal 60, a commodity that the user is about to purchase, in the purchased commodity data region 4226, purchased commodity data about the commodity is stored. The purchased commodity data includes a commodity code, a unit price, the number of sold items (the number of items), a commodity name, a sales amount, and a tax amount of a purchased commodity purchased by the customer. The subtotal amount region 4227 is amount data indicating a total amount of a sales amount and a tax amount about all purchased commodities purchased by the customer, calculated based on the purchased commodity data stored in the purchased commodity data region 4226. The amount data can be updated every time the customer perform registration operation for the commodity that the customer is about to purchase.

FIG. 6 is a block diagram illustrating a main part circuit configuration of the information terminal 60. The information terminal 60 includes a processor 61, a main memory 62, an auxiliary storage device 63, a wireless unit 64, a touch panel 65, a scanner 66, a reader 67, a camera 68, a printer 69, and a system transmission line BUS. The system transmission line BUS includes an address bus, a data bus, and a control signal line. In the information terminal 60, the processor 61, the main memory 62, the auxiliary storage device 63, the wireless unit 64, the touch panel 65, the scanner 66, the reader 67, the camera 68, and the printer 69 are connected to the system transmission line BUS. In the information terminal 60, a computer is configured by the processor 61, the main memory 62, and the auxiliary storage device 63 and the system transmission line BUS that connects the forgoing.

The processor 61 is equivalent to a central part of the computer. The processor 61 controls the units in order to realize various functions of the information terminal 60 according to an operating system or application programs. The processor 61 is, for example, a CPU.

The main memory 62 is equivalent to amain storage portion of the computer. The main memory 62 includes a nonvolatile memory region and a volatile memory region. The main memory 62 stores the operating system and the application programs in the nonvolatile memory region. The main memory 62 sometimes stores, in the nonvolatile or volatile memory region, data necessary for the processor 61 to execute processing for controlling the units. The main memory 62 uses the volatile memory region as a work area in which data is rewritten as appropriate by the processor 61. The nonvolatile memory region is, for example, a ROM. The volatile memory region is, for example, a RAM.

The auxiliary storage device 63 is equivalent to an auxiliary storage portion of the computer. For example, an EEPROM, a HDD, or an SSD can be the auxiliary storage device 63. The auxiliary storage device 63 saves data used by the processor 61 in performing various kinds of processing, data created by the processing in the processor 61, or the like. The auxiliary storage device 63 sometimes stores the application programs.

The wireless unit 64 performs wireless communication of data according to a wireless communication protocol between the wireless unit 64 and the access point 70.

The touch panel 65 can function as both of an input device and a display device of the information terminal 60. The touch panel 65 detects a touch position on a displayed image and outputs information concerning the touch position to the processor 61. In commodity registration performed by the customer, the customer touches (this touch operation is hereinafter referred to as “press”) positions corresponding to a commodity name and an image of a commodity displayed on the touch panel 65, whereby a commodity code of a commodity that the customer desires to purchase is input.

It is naturally possible to return the commodity, the commodity code of which is input, (cancel the commodity code). In this case, the cancellation of the commodity is performed by causing the touch panel 65 to display a commodity cancellation key or the like and, after the commodity cancellation key is pressed, reading the commodity code of the commodity with the scanner 66 or the like.

The scanner 66 reads a code symbol such as a barcode or a two-dimensional data code attached to a commodity. A code symbol representing a commodity code of the commodity is attached to the commodity. The scanner 66 outputs data of the read code symbol to the processor 61. The scanner 66 may be a type for reading the code symbol by scanning laser light or may be a type for reading the code symbol from an image captured by an imaging device. The scanner 66 reads not only the barcode attached to the commodity but also a barcode or the like attached to the member card to thereby output data to the processor 61. Consequently, the customer can input a member code with the scanner 66.

The reader 67 reads data recorded in a recording medium and outputs the read data to the processor 61. The reader 67 is a magnetic card reader if the recording medium is a magnetic card. The reader 67 is an IC card reader if the recording medium is a contact IC card. An RFID reader is used as the reader 67 in the case of a noncontact IC card or a recording medium that uses RFID (Radio Frequency Identification) such as a smartphone.

The camera 68 is provided in the cart C to be able to photograph, from above, a basket placed in a basket receiving section of the cart C. The camera 68 is a camera for monitoring whether the customer, who is the user of the cart C, correctly puts purchased commodities in the basket.

The printer 69 is a receipt printer for issuing a receipt if settlement is completed by electronic money.

In the information terminal 60 including the circuit components explained above, the processor 61, the main memory 62, the auxiliary storage device 63, the wireless unit 64, and the touch panel 65 are configured by a tablet terminal TM for a cart POS. The information terminal 60 is configured by electrically connecting the scanner 66, the reader 67, the camera 68, and the printer 69 to the table terminal TM.

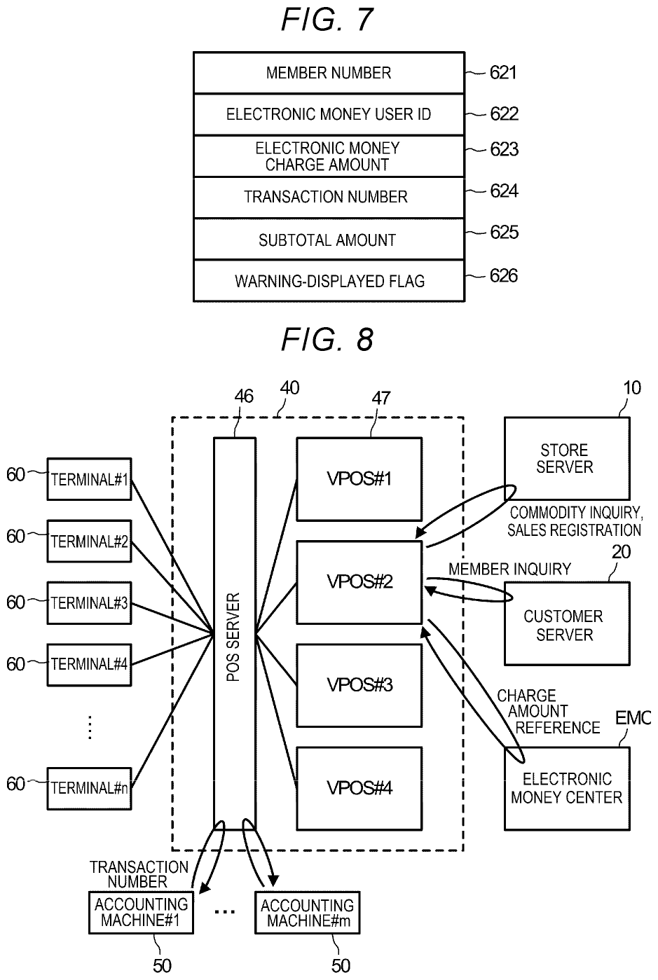

FIG. 7 is a schematic diagram illustrating a main data structure of the main memory 62. As illustrated in FIG. 7, in a work area in which data is rewritten as appropriate by the processor 61 of the main memory 62, a member number region 621, an electronic money user ID region 622, an electronic money charge amount region 623, a transaction number region 624, and a subtotal amount region 625, and the like, which are regions for storing data relating to purchase of the customer who operates the information terminal 60, are provided. That is, the data relating to the purchase includes a member number stored in the member number region 621, an electronic money user ID stored in the electronic money user ID region 622, an electronic money charge amount stored in the electronic money charge amount region 623, a transaction number stored in the transaction number region 624, and a subtotal amount stored in the subtotal amount region 625. The electronic money user ID and the electronic money charge amount are data sent from the mobile controller 40 and stored in the electronic money user ID region 4222 and the electronic money charge amount region 4223 of the shopping basket memory 422 corresponding to the customer created in the main memory 42 of the mobile controller 40. Similarly, the subtotal amount is data sent from the mobile controller 40 and stored in the purchased commodity data region 4226 of the corresponding shopping basket memory 422.

In the work area, a warning-displayed flag region 626 for storing a warning-displayed flag is further provided. The warning-displayed flag is a flag that is set if warning display explained below is performed.

FIG. 8 is a schematic diagram illustrating an overview of software configuration and operation of the mobile controller 40. The processor 41 of the mobile controller 40 can realize two types of functional units, that is, a POS server 46 and a plurality of (in this example, four) virtual POSs (in FIG. 8, described as VPOS) 47, by executing information processing according to a controller program. The controller program is stored in the main memory 42 or the auxiliary storage device 43.

The POS server 46 has a function of allocating, following a start of use by a customer, who is a user of any one of n (n is an integer equal to or larger than one) information terminals 60, the information terminal 60 to any one of the virtual POSs 47 according to a state of use of the four virtual POSs 47.

The respective virtual POSs 47 virtually realize functions of four POS terminals using, for example, four shopping basket memories 422 formed in the main memory 42. Therefore, in this example, the number of the information terminals 60 usable at a time is sixteen. The number of the virtual POSs 47 or the number of the shopping basket memories 422 used and managed by one virtual POS may be changed according to the number of the information terminals 60 included in the store.

The respective virtual POSs 47 have a function of performing inquiry about commodity data between the virtual POSs 47 and the store server 10 and performing registration of sales data. Further, the respective virtual POSs 47 has a function of performing inquiry about whether a customer is a member between the virtual POSs 47 and the customer server 20, a function of performing inquiry about a charge balance of electronic money between the virtual POSs 47 and the electronic money center EMC, and the like.

The POS server 46 has a function of acquiring, according to transaction numbers from respective m (m is an integer equal to or larger than 1) accounting machines 50, settlement data including purchased commodity data from the virtual POSs 47 corresponding to the transaction number, transmitting the settlement data to the accounting machines 50, and causing the accounting machines 50 to perform settlement.

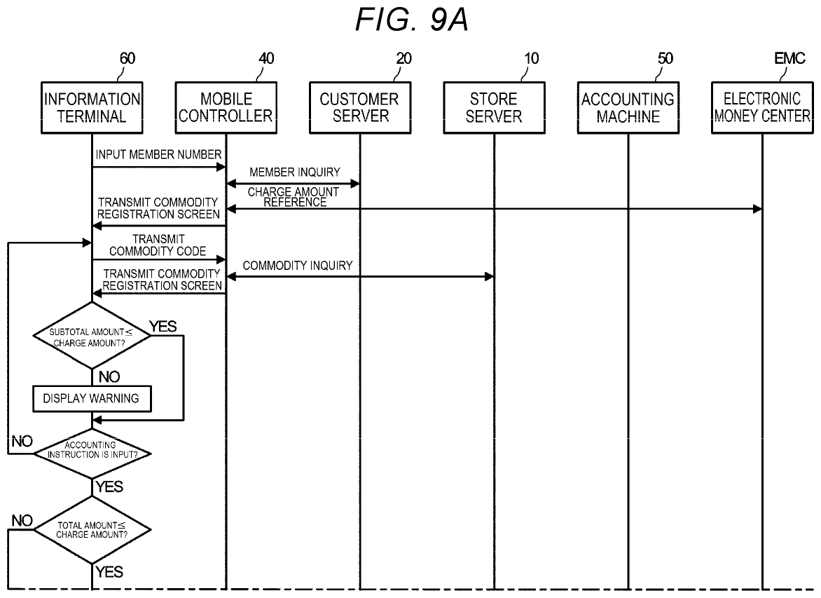

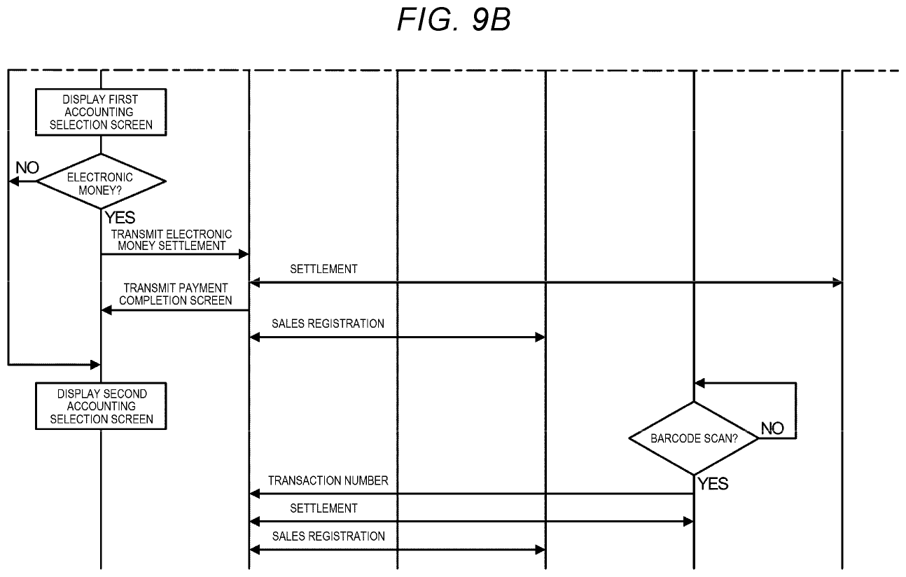

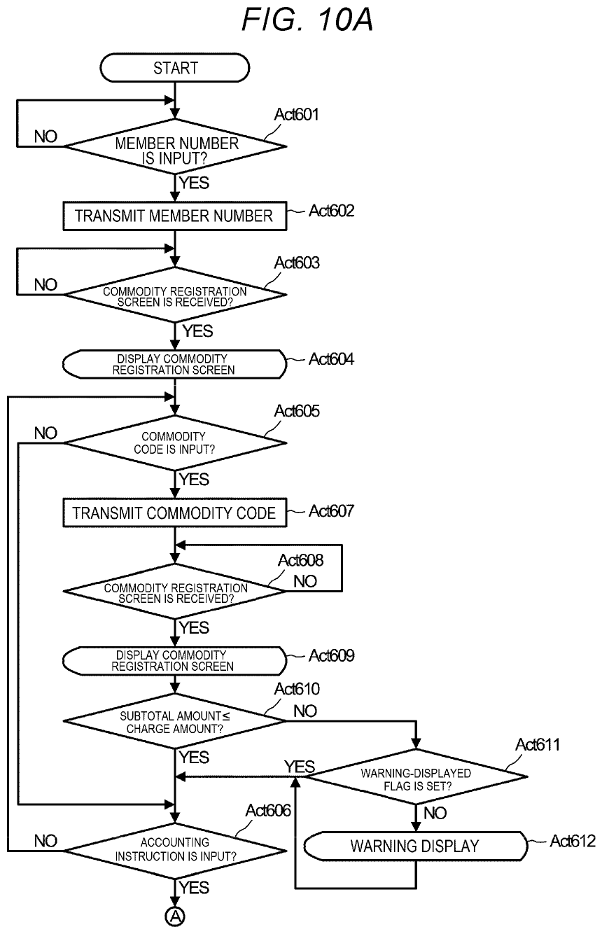

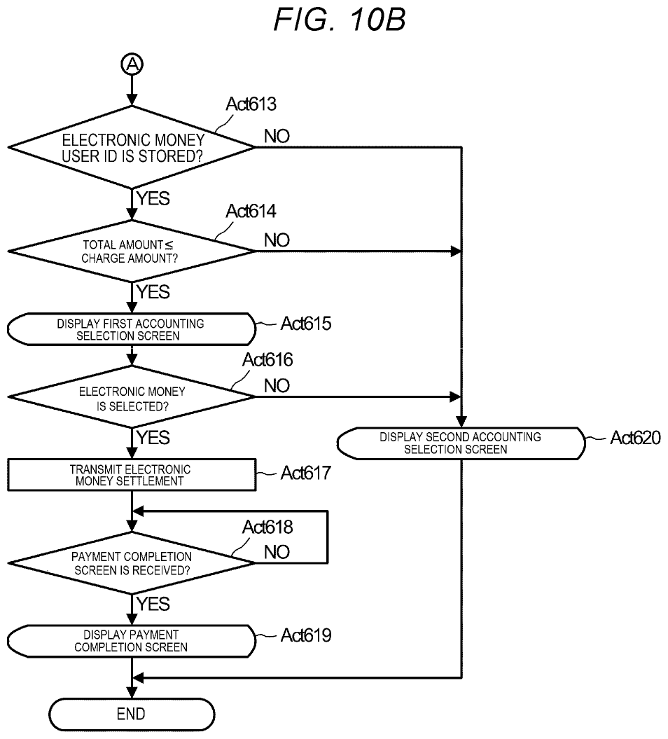

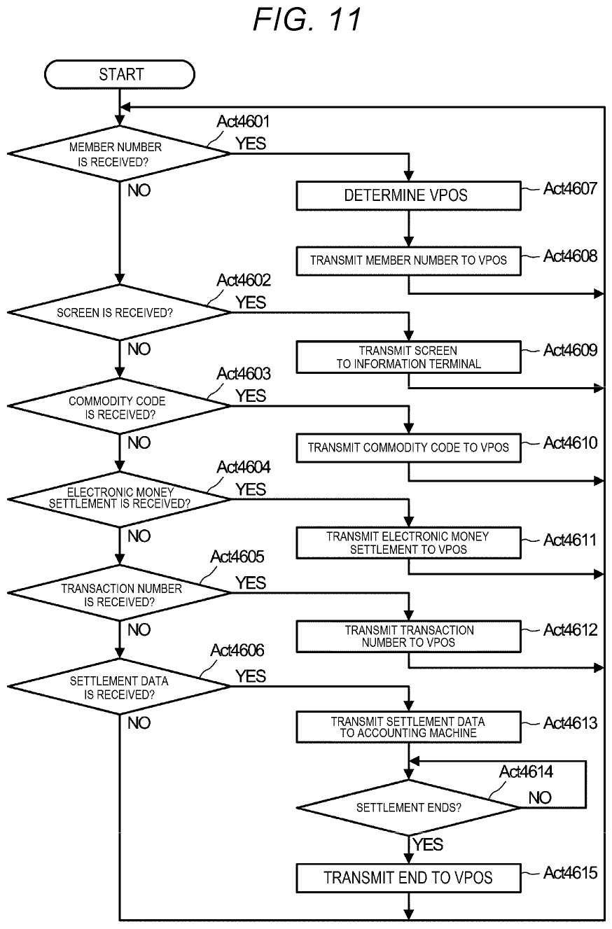

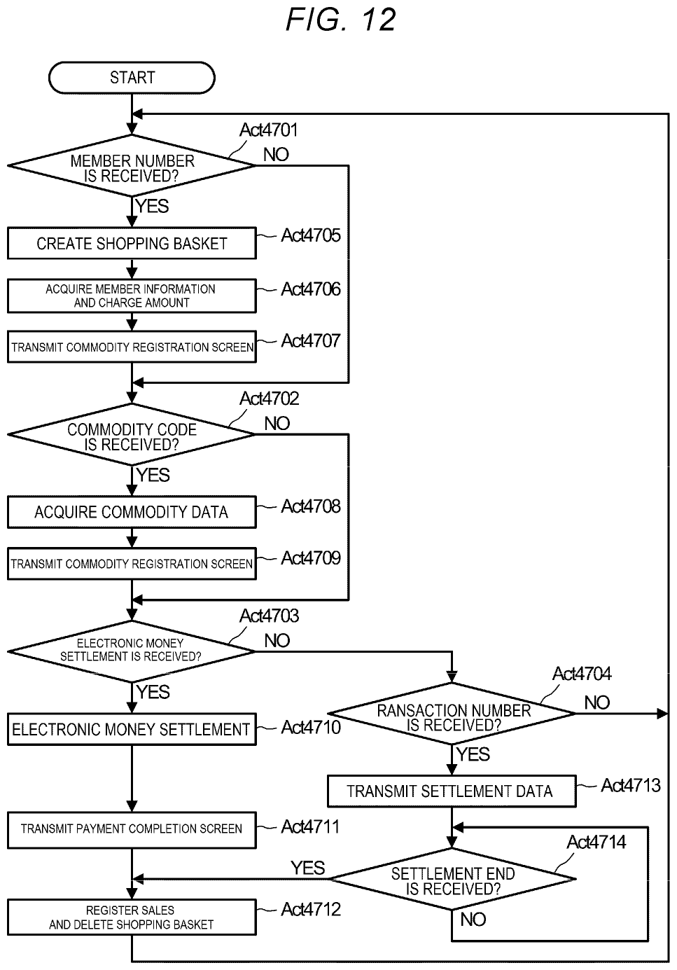

FIGS. 9A and 9B are sequence charts illustrating an overview of an overall operation of the cart POS system 1. FIGS. 10A and 10B are flowcharts illustrating a procedure of main information processing executed by the processor 61 of the information terminal 60 according to a terminal program. The terminal program is stored in the main memory 62 or the auxiliary storage device 63. FIG. 11 is a flowchart illustrating a procedure of main information processing of a POS server operation executed by the processor 41 of the mobile controller 40 according to a POS server program. FIG. 12 is a flowchart illustrating a procedure of main information processing of a VPOS operation executed by the processor 41 according to a VPOS program. The POS server program and the VPOS program are stored in the main memory 42 or the auxiliary storage device 43.

A main operation of the cart POS system 1 in which the customer, who is the member, performs registration to settlement of purchased commodities by himself or herself using the information terminal 60 of the cart C is explained with reference to the sequence charts and the flowcharts. The operation explained below is an example. A procedure of the operation is not particularly limited if the same result is obtained.

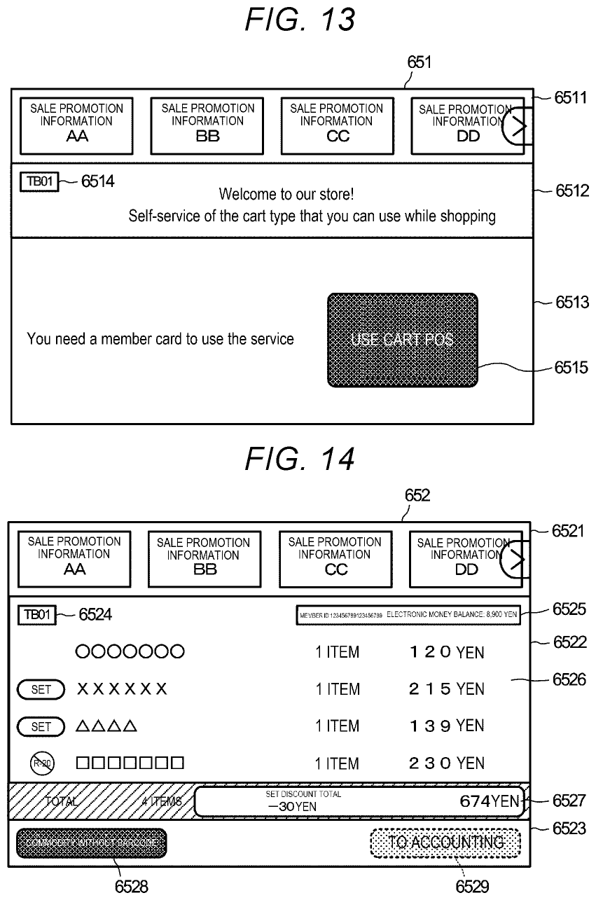

In a standby state, the processor 61 of the information terminal 60 causes the touch panel 65 to display a login screen. FIG. 13 is a schematic diagram illustrating an example of display of a login screen 651 in the information terminal 60. The login screen 651 is a screen for instructing the member to perform login operation. The login screen 651 includes a sales promotion information display area 6511, an information presentation area 6512, and an operation area 6513.

The sales promotion information display area 6511, which is set by the store server 10, displays sales promotion information such as a campaign, a bargain, and a coupon. The information presentation area 6512 is an area for displaying information desired to be communicated to the customer. In FIG. 13, a terminal number 6514 for specifying the information terminal 60 is displayed in the area. A terminal number is stored in the main memory 62 or the auxiliary storage device 63 in advance by the processor 61 according to the terminal program. The operation area 6513 is an area for displaying a button for receiving operation of the customer. The button indicates a region that the customer touches on the screen of the touch panel 65. The button is displayed in a square shape simulating a mechanical button switch. In FIG. 13, a [use cart POS] button 6515 for declaring a use start is displayed in the operation area 6513.

In the standby state, the touch panel 65 may be extinguished. According to a touch on the touch panel 65 by the customer who does shopping using the cart C, the processor 61 may cause the touch panel 65 to display the login screen 651.

If the [use cart POS] button 6515 is pressed, the processor starts the information processing by the procedure illustrated in the flowcharts of FIGS. 10A and 10B. First, in Act 601, the processor 61 waits for an input of a member number. The customer, who is the member, carries the member card in which the member number of the customer is recorded. The customer causes the reader 67 or the scanner 66 to read data of the member card. If the data of the member card is read by the reader 67 or the scanner 66, the data of the member card is given to the processor 61. The processor 61 receives the data from the reader 67 and, if confirming that the data is the data of the member card including the member number, determines that the member number is input. That is, the processor 61 determines YES in Act 601 and proceeds to Act 602.

In Act 602, the processor 61 controls the wireless unit 64 to transmit a login command including the member number and the terminal number to the mobile controller 40. According to the control, the wireless unit 64 wirelessly transmits the login command. The login command is received by the access point 70 and transmitted to the mobile controller 40 through the network NW.

The processor 41 of the mobile controller 40 carries out the operation of the POS server 46 and the operation of the virtual POS 47 in parallel. These kinds of processing are explained with reference to the flowchart of FIG. 11.

The processor 41 operating as the POS server 46 according to the POS server program waits for reception of a command from the accounting machine 50 or the information terminal 60 or data from the virtual POS 47. That is, in Act 4601, the processor 41 determines whether a login command including a member number and the like is received from any information terminal 60. If determining that the login command including the member number and the like is not received, the processor 41 determines NO in Act 4601 and proceeds to Act 4602.

In Act 4602, the processor 41 determines whether data for causing any information terminal 60 to display some screen that the processor 41 should cause any information terminal 60 to display is received from any virtual POS 47. The screen transmitted from the virtual POS 47 to the information terminal 60 is a screen relating to commodity registration and settlement and includes, for example, a commodity registration screen and a payment completion screen explained below. If determining that data for causing the information terminal 60 to display some screen is not received, the processor 41 determines NO in Act 4602 and proceeds to Act 4603.

In Act 4603, the processor 41 determines whether a commodity registration command including a commodity code is received from any information terminal 60. If determining that the commodity registration command is not received, the processor 41 determines NO in Act 4603 and proceeds to Act 4604.

In Act 4604, the processor 41 determines whether an electronic money settlement command is received from any information terminal 60. If determining that the electronic money settlement command is not received, the processor 41 determines NO in Act 4604 and proceeds to Act 4605.

In Act 4605, the processor 41 determines whether a transaction inquiry command including a transaction number is received from any accounting machine 50. If determining that the transaction inquiry command is not received, the processor 41 determines NO in Act 4605 and proceeds to Act 4606.

In Act 4606, the processor 41 determines whether settlement data is received from any virtual POS 47. If determining that settlement data is not received, the processor 41 determines NO in Act 4606 and proceeds to Act 4601.

If receiving the login command including the member number and the like from any information terminal 60 via the communication interface 44, the processor 41 determines YES in Act 4601 and proceeds to Act 4607. In Act 4607, the processor 41 discriminates states of use of the four virtual POSs 47 referring to the VPOS table 421 of the main memory 42 and determines, according to an idle state, the virtual POS 47 used for the information terminal 60. The processor 41 correlates the terminal number of the information terminal 60 with the determined VPOS 47 and registers the terminal number in the VPOS table 421. In Act 4608, the processor 41 transmits the received login command including the member number and the like to the determined virtual POS 47. That is, the processor 41 passes the login command to the VPOS program. Thereafter, the processor 41 proceeds to Act 4601.

The operation is explained with reference to the flowchart of FIG. 12. The processor 41 operating as each of the virtual POSs 47 according to the VPOS program waits for a command being received from the POS server 46, that is, a command being passed from the POS server program.

That is, in Act 4701, the processor 41 determines whether a login command including a member number and the like is received. If determining that the login command is not received, the processor 41 determines NO in Act 4701 and proceeds to Act 4702. In Act 4702, the processor 41 determines whether a commodity registration command including a commodity code is received. If determining that the commodity registration command is not received, the processor 41 determines NO in Act 4702 and proceeds to Act 4703. In Act 4703, the processor 41 determines whether an electronic money settlement command is received. If determining that the electronic money settlement command is not received, the processor 41 determines NO in Act 4703 and proceeds to Act 4704. In Act 4704, the processor 41 determines whether a transaction inquiry command including a transaction number is received. If determining that the transaction inquiry command is not received, the processor 41 determines NO in Act 4704 and proceeds to Act 4701.

If receiving the login command including the member number and the like from the POS server 46, the processor 41 determines YES in Act 4701 and proceeds to Act 4705. In Act 4705, the processor 41 forms VPOS data, that is, the shopping basket memory 422 in the main memory 42. The processor 41 causes the shopping basket memory 422 to store a VPOS number for identifying the virtual POS 47 in the VPOS-in-use region 4224 of the shopping basket memory 422.

Thereafter, in Act 4706, the processor 41 acquires member information and a charge amount.

That is, the processor 41 controls the communication interface 44 to transmit the member number to the customer server 20 through the network NW and causes the customer server 20 to perform authentication of the member. If receiving a response that the member authentication is invalid from the customer server 20, the processor 41 notifies the member authentication invalidity to the POS server 46, causes the POS server 46 to transmit a rejection response command to the information terminal 60, and deletes the shopping basket memory 422 created in Act 4705. If the member authentication is valid, the processor 41 writes the member number and the terminal number in the member number region 4221 of the shopping basket memory 422 and causes the shopping memory 422 to store a unique transaction number in the transaction number region 4225 of the shopping basket memory 422.

The processor 41 controls the communication interface to request the customer server 20 to transmit member information, in particular, an electronic money identification code and an electronic money user ID of the customer saved in the member settlement database 21. If acquiring the electronic money identification code and the electronic money user ID from the customer server 20, the processor 41 causes the shopping basket memory 422 to store the electronic money identification code and the electronic money user ID in the electronic money user ID region 4222 of the shopping basket memory 422. Further, the processor 41 controls the communication interface 44 to transmit a charge amount reference instruction to the communication server 30 together with the electronic money identification code and the electronic money user ID. The communication server 30, which receives the charge amount reference instruction, performs charge amount reference on the electronic money center EMC via the network INT using the electronic money identification code and the electronic money user ID. The electronic money center EMC, which receives the charge amount reference, retrieves a charge amount of electronic money indicated by the electronic money identification code using the electronic money user ID as a key and returns an obtained charge amount. The processor 41 acquires the returned charge amount of the electronic money of the customer received by the communication server 30 and causes the shopping basket memory 422 to store the charge amount in the electronic money charge amount region 4223 of the shopping basket memory 422.

Thereafter, in Act 4707, the processor 41 transmits data for causing the information terminal 60 to display a commodity registration screen to the POS server 46. That is, the processor 41 passes the data for causing the information terminal 60 to display the commodity registration screen to the POS server program. The data can include the member number and the terminal number, the electronic money charge amount, the transaction number, the purchased commodity data, and the subtotal stored in the shopping basket memory 422. The processor 41 may create, as the data for causing the information terminal 60 to display the commodity registration screen, image data of a commodity registration screen displayed on the information terminal 60 and may include the image data in the data. Thereafter, the processor 41 proceeds to Act 4702.

If receiving the data for causing the information terminal 60 to display a screen from the virtual POS 47, the processor 41 of the mobile controller 40 operating as the POS server 46 determines YES in Act 4602 and proceeds to Act 4609. In Act 4609, the processor 41 specifies the information terminal 60 at a transmission destination according to the terminal number and controls the communication interface 44 to transmit the data for causing the information terminal 60 to display the commodity registration screen to the information terminal 60. The data to be transmitted may be the data itself received from the virtual POS 47 or another data may be further added. For example, the processor 41 may create, based on the data from the virtual POS 47, image data of the commodity registration screen displayed on the information terminal 60 and include the image data in the data. Thereafter, the processor 41 proceeds to Act 4601.

In Act 603, the processor 61 of the information terminal 60, which controls the wireless unit 64 to transmit the member number in Act 602, waits for reception of the data for displaying the commodity registration screen from the mobile controller 40. If receiving, with the wireless unit 64, the data for displaying the commodity registration screen from the mobile controller 40, the processor 61 determines YES in Act 603 and proceeds to Act 604. In Act 604, the processor 61 stores a member number, an electronic money charge amount, a transaction number, and a subtotal amount included in the data for displaying the commodity registration screen received in Act 604 in the member number region 621, the electronic money charge amount region 623, the transaction number region 624, and the subtotal amount region 625 of the main memory 62. The processor 61 causes the touch panel 65 to display a commodity registration screen including display of the member number and the electronic money charge amount stored in the memory number region 621 and the electronic money charge amount region 623. The commodity registration screen is a screen for displaying a purchased commodity list including commodity names and prices and a total amount of commodities purchased by the customer. Thereafter, the processor 61 proceeds to Act 605.

In Act 605, the processor 61 confirms whether commodity registration operation is performed. If the commodity registration operation is not performed, the processor 61 determines NO in Act 605 and proceeds to Act 606. In Act 606, the processor 61 confirms whether an accounting instruction is input. If the accounting instruction is not input, the processor 61 determines NO in Act 606 and proceeds to Act 605. In this way, the processor 61 waits for the commodity registration operation or the accounting instruction to be performed.

The customer, who confirms the commodity registration screen, moves around a selling floor and stores a commodity that the customer is about to purchase, a so-called purchased commodity in the cart C. Before storing the purchased commodity in the cart C, the customer operates the scanner 66 and reads a code symbol attached to the commodity. If the code symbol is read by the scanner 66, a commodity code represented by the code symbol is input to the information terminal 60. That is, registration operation for the commodity identified by the commodity code is performed. The commodity code may be input by touching a commodity name or a commodity image displayed on the touch panel 65.

If the commodity registration operation is performed, the processor 61 determines YES in Act 605 and proceeds to Act 607. In Act 607, the processor 61 controls the wireless unit 64 to transmit a commodity registration command to the mobile controller 40. The wireless unit 64 wirelessly transmits the commodity registration command according to the control. The commodity registration command is received by the access point 70 and transmitted to the mobile controller 40 via the network NW. The commodity registration command includes the commodity code read by the scanner 66 and the terminal number and the member number stored in the main memory 62 or the auxiliary storage device 63, and the like.

If receiving the commodity registration command, the processor 41 of the mobile controller 40 operating as the POS server 46 determines YES in Act 4603 and proceeds to Act 4610. In Act 4610, the processor 41 refers to the VPOS table 421 and transmits the commodity registration command to the virtual POS 47 corresponding to the terminal number included in the commodity registration command. That is, the processor 41 passes the commodity registration command to the VPOS program. Thereafter, the processor 41 proceeds to Act 4601.

If receiving the commodity registration command including the commodity code from the POS server 46, the processor 41 of the mobile controller 40 operating as the virtual POS 47 determines YES in Act 4702 and proceeds to Act 4708.

In Act 4708, the processor 41 acquires commodity data from the store server 10. That is, the processor 41 controls, according to the commodity code included in the commodity registration command, the communication interface 44 to transmit an inquiry about the commodity data to the store server 10 and acquires the commodity data corresponding to the commodity code from the store server 10. The processor 41 creates purchased commodity data based on the acquired commodity data and writes the purchased commodity data in the purchased commodity data region 4226 of the shopping basket memory 422 corresponding to purchase commodity data based on the member number included in the commodity registration command.

Thereafter, in Act 4709, the processor 41 transmits, to the POS server 46, data for causing the information terminal 60 to display the updated commodity registration screen. That is, the processor 41 passes the data for causing the information terminal 60 to display the commodity registration screen to the POS server program. As in Act 4707, the data can include the member number and the terminal number, the electronic money charge amount, the transaction number, the purchased commodity data, and the subtotal amount stored in the shopping basket memory 422. The terminal number can be used for discriminating a transmission destination. However, the member number, the electronic money charge amount, and the transaction number may not be included in the data. Since the subtotal amount can also be calculated on the information terminal 60 side based on the purchased commodity data, the subtotal amount may not be included in the data. Thereafter, the processor 41 proceeds to Act 4703.

If receiving the data for causing the information terminal 60 to display the screen from the virtual POS 47, as explained above, the processor 41 operating as the POS server 46 determines YES in Act 4602. In Act 4069, the processor 41 controls the communication interface 44 to transmit the data for causing the information terminal 60 to display the commodity registration screen to the information terminal 60. Thereafter, the processor 41 proceeds to Act 4601.

In Act 608, the processor 61 of the information terminal 60, which controls the wireless unit 64 to transmit the commodity code in Act 607, waits for reception of the data for displaying the commodity registration screen from the mobile controller 40. If receiving, with the wireless unit 64, the data for displaying the commodity registration screen from the mobile controller 40, the processor 61 determines YES in Act 608 and proceeds to Act 609. In Act 609, the processor 61 acquires or calculates a subtotal amount from the received data for displaying the commodity registration screen and stores the subtotal amount in the subtotal amount region 625 of the main memory 62. The processor 61 causes the touch panel 65 to display the commodity registration screen including display of the stored amount. Thereafter, the processor 61 proceeds to Act 610.

FIG. 14 is a schematic diagram illustrating an example of display of a commodity registration screen 652 in the information terminal 60. The commodity registration screen 652 includes a sales promotion information display area 6521, an information presentation area 6522, and an operation area 6523. These areas are areas having the same functions as the functions of the sales promotion information display area 6511, the information presentation area 6512, and the operation areas 6513 of the login screen 651.

However, sales promotion information displayed in the sales promotion information display area 6521 may be changed according to a commodity registered by the customer.

A terminal number 6524 for specifying the information terminal 60, a member number and electronic money charge amount 6525, a commodity information list 6526 of registered commodities, and a total amount 6527 are displayed in the information presentation area 6522. The total amount 6527 corresponds to the amount stored in the subtotal amount region 625 of the main memory 62. In FIG. 14, the total amount 6527 is illustrated as the total amount of the commodity amount and the tax amount. However, naturally, the commodity amount and the tax amount may be separately displayed.

A [commodity without barcode] button 6528 is displayed in the operation area 6523. A code symbol is sometimes not attached to a part of perishables. If a code symbol is not attached to a purchased commodity, the customer presses the [commodity without barcode] button 6528. According to this touch operation, the processor 61 narrows the information presentation area 6512 and enlarges the operation area 6523 or pops up an operation screen on the information presentation area 6512 to display a list of commodities not attached with code symbols. The customer can register a commodity code of a commodity corresponding to a purchased commodity by touching a region where the commodity is displayed.

In the operation area 6523, a [to accounting] button 6529 operated if the customer ends purchase of a commodity and desires payment is displayed. If the [to accounting] button 6529 is pressed, a first accounting screen or a second accounting screen is displayed according to a situation. In this embodiment, the customer can operate the [to accounting] button 6529 if the information terminal 60 enters an accounting place, so to speak, a predetermined accounting area where the accounting machines 50 and store clerks are disposed. In FIG. 14, since the information terminal 60 is not in the accounting area, as indicated by a broken line, a display form indicates that the [to accounting] button 6529 cannot be operated. The position of the information terminal 60 can be measured by, for example, the wireless unit 64 using BLE (Blue tooth Low Energy (Blue tooth is a registered trademark)) or UWB (Ultra Wide Band).

The accounting area is an area where the accounting machines 50 are set and is an area where the store clerks are disposed. A suppression effect such as shoplifting prevention is generated by performing settlement by electronic money or the like in the accounting area where the store clerks are disposed. The accounting area is desirably clearly shown in a form with which it is possible to discriminate whether the information terminal 60 enters the accounting area.

In Act 610, the processor 61 compares the amount stored in the electronic money charge amount region 623 of the main memory 62 and the amount stored in the subtotal amount region 625 and confirms whether the subtotal amount is equal to or smaller than the charge amount. If the subtotal amount is equal to or smaller than the charge amount, the processor 61 determines YES in Act 610 and proceeds to Act 606. If the subtotal amount is larger than the charge amount, the processor 61 determines NO in Act 610 and proceeds to Act 611.

In Act 611, the processor 61 confirms whether the warning-displayed flag stored in the warning-displayed flag region 626 of the main memory 62 is set. If the warning-displayed flag is not set, the processor 61 determines NO in Act 611 and proceeds to Act 612. In Act 612, the processor 61 causes the touch panel 65 to perform warning display indicating that a charge amount of electronic money runs short. At this time, in order to store indication that the warning display is performed, the processor 61 sets the warning-displayed flag stored in the warning-displayed flag region 626 of the main memory 62. Thereafter, the processor 61 proceeds to Act 606.

If the warning-displayed flag is set in Act 611, the processor 61 determines YES in Act 611 and proceeds to Act 606.

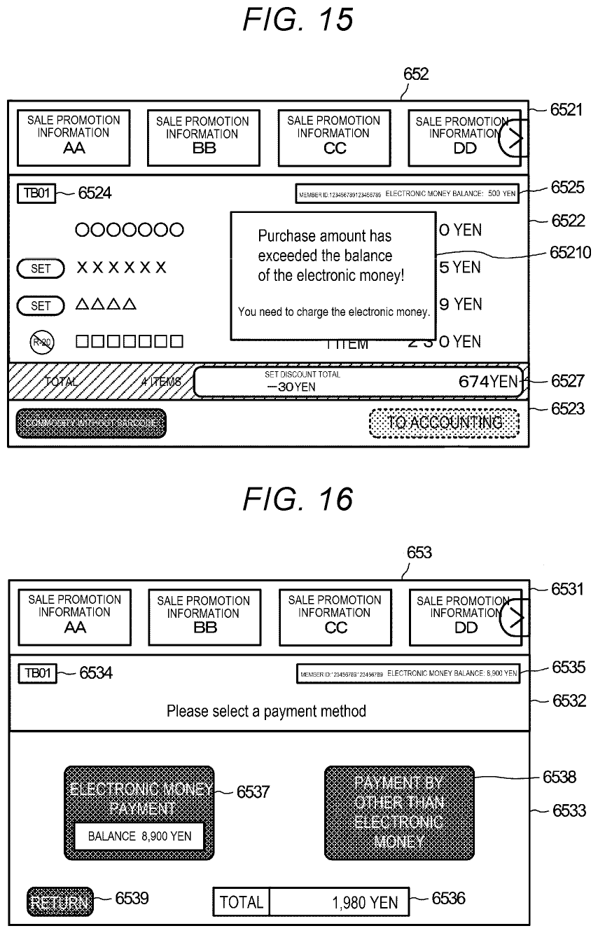

FIG. 15 is a schematic diagram illustrating an example of warning display 65210 in the information terminal 60. The warning display 65210 can be popup-displayed on the information presentation area 6522 on the commodity registration screen 652. The warning display 65210 may be continued until the next commodity registration is performed or may be performed only for a predetermined time such as ten seconds.

In this way, the registration of the commodity and the updated display of the commodity registration screen corresponding to the registration of the commodity are repeated until an accounting instruction is input in Act 606. However, the warning display in Act 612 is performed if it is determined in first determination that the subtotal amount is larger than the charge amount.

If the customer finishing the shopping proceeds to the accounting area and presses the [to accounting] button 6529, the processor 61 determines YES in Act 606 and proceeds to Act 613. In Act 613, the processor 61 determines whether the electronic money user ID is stored in the electronic money user ID region 622 of the main memory 62. If the electronic money user ID is not stored in the electronic money user ID region 622, the processor 61 determines NO in Act 613. If the electronic money user ID is not stored in the electronic money user ID region 622, settlement by the electronic money cannot be performed in the information terminal 60. In such a case, the processor 61 proceeds to Act 620. On the other hand, if the electronic money user ID is stored, the processor 61 determines YES in Act 613 and proceeds to Act 614. In Act 614, the processor 61 compares the amount stored in the electronic money charge amount region 623 of the main memory 62 and the total amount of the registered commodities stored in the subtotal amount region 625 and confirms whether that total amount is equal to or smaller than the charge amount. If the total amount is equal to or smaller than the charge amount, the processor 61 determines YES in Act 614 and proceeds to Act 615. In Act 615, the processor 61 causes the touch panel 65 to display a first accounting selection screen.

FIG. 16 is a schematic diagram illustrating an example of the display of a first accounting selection screen 653 in the information terminal 60. The first accounting selection screen 653 includes a sales promotion information display area 6531, an information presentation area 6532, and an operation area 6533. These areas are areas having the same functions as the functions of the sales promotion information display area 6511, the information presentation area 6512, and the operation area 6513 of the login screen 651.

On the first accounting selection screen 653, a terminal number 6534 for specifying the information terminal 60 and a member number and electronic money charge amount 6535 are displayed in the information presentation area 6532.

In the operation area 6533, a payment total amount 6536, an [electronic money payment] button 6537, and a [payment by other than electronic money] button 6538 are displayed. An amount presented in the payment total amount 6536 is the amount stored in the subtotal amount region 625 of the main memory 62. The [electronic money payment] button 6537 is a button for the customer to select the payment by the electronic money. In the [ electronic money payment] button 6537, in order to assist payment method selection by the customer, a charge balance of the electronic money is clearly shown in addition to the member number and electronic money charge amount 6535 in the information presentation area 6532. The [payment by other than electronic money] button 6538 is a button for the customer to select payment by other than the electronic money, for example, cash payment or credit card payment.

In the operation area 6533, further, a [return] button 6539 for the customer to select return to the commodity registration screen, which is the immediately preceding display screen.

In Act 616, the processor 61 confirms whether the [electronic money payment] button 6537 in the first accounting selection screen 653 is pressed and the payment by the electronic money is selected. If the payment by the electronic money is selected, the processor 61 determines YES in Act 616 and proceeds to Act 617. In Act 617, the processor 61 controls the wireless unit 64 to transmit an electronic money settlement command to the mobile controller 40. According to the control, the wireless unit 64 wirelessly transmits the electronic money settlement command. The electronic money settlement command is received by the access point 70 and transmitted to the mobile controller 40 via the network NW. The electronic money settlement command includes the terminal number, the member number, and the like stored in the main memory 62 or the auxiliary storage device 63.

If receiving the electronic money settlement command, the processor 41 of the mobile controller 40 operating as the POS server 46 determines YES in Act 4604 and proceeds to Act 4611. In Act 4611, the processor 41 refers to the VPOS table 421 and transmits the electronic money settlement command to the virtual POS 47 corresponding to the terminal number included in the electronic money settlement command. That is, the processor 41 passes the electronic money settlement command to the VPOS program. Thereafter, the processor 41 proceeds to Act 4601.

If receiving the electronic money settlement command from the POS server 46, in Act 4703, the processor 41 of the mobile controller 40 operating as the virtual POS 47 determines YES in Act 4703 and proceeds to Act 4710. In Act 4710, the processor 41 carries out settlement processing by the electronic money. That is, the processor 41 controls the communication interface 44 to request the customer server 20 to transmit the member information, in particular, the electronic money identification code of the customer saved in the member settlement database 21. By saving the electronic money identification code acquired in Act 4706 in the shopping basket memory 422 together with the member number, it is also possible to omit processing relating to the acquisition of the electronic money identification code. The processor 41 controls the communication interface 44 to transmit a settlement instruction to the communication server 30 together with the electronic money identification code and the payment total amount. The communication server 30, which receives the settlement instruction, requests the electronic money center EMC via the network INT to perform electronic money settlement using the electronic money identification code and the total amount. If receiving a settlement end notification from the electronic money center EMC, the communication server 30 transmits the settlement end notification to the mobile controller 40 via the network NW.

If receiving the settlement end notification with the communication interface 44, the processor 41 proceeds to Act 4711. In Act 4711, the processor 41 transmits data for causing the information terminal 60 to display a payment completion screen to the POS server 46. That is, the processor 41 passes the data for causing the information terminal 60 to display the payment completion screen to the POS server program. The data can include receipt information for printing a receipt with the printer 69 of the information terminal 60.

If receiving the data for causing the information terminal 60 to display the screen from the virtual POS 47, as explained above, the processor 41 operating as the POS server 46 determines YES in Act 4602. In Act 4609, the processor 41 controls the communication interface 44 to transmit data for causing the information terminal 60 to display the payment completion screen to the information terminal 60. Thereafter, the processor 41 proceeds to Act 4601.

In Act 618, the processor 61 of the information terminal 60, which controls the wireless unit 64 to transmit the electronic money settlement in Act 617, waits for reception of the data for displaying the payment completion screen from the mobile controller 40. If receiving, with the wireless unit 64, the data for displaying the payment completion screen from the mobile controller 40, the processor 61 determines YES in Act 618 and proceeds to Act 619. In Act 619, the processor 61 causes the printer 69 to print a receipt based on the receipt information included in the received data for displaying the payment completion screen and causes the touch panel 65 to display the payment completion screen. Thereafter, the processor 61 shifts to the standby state.

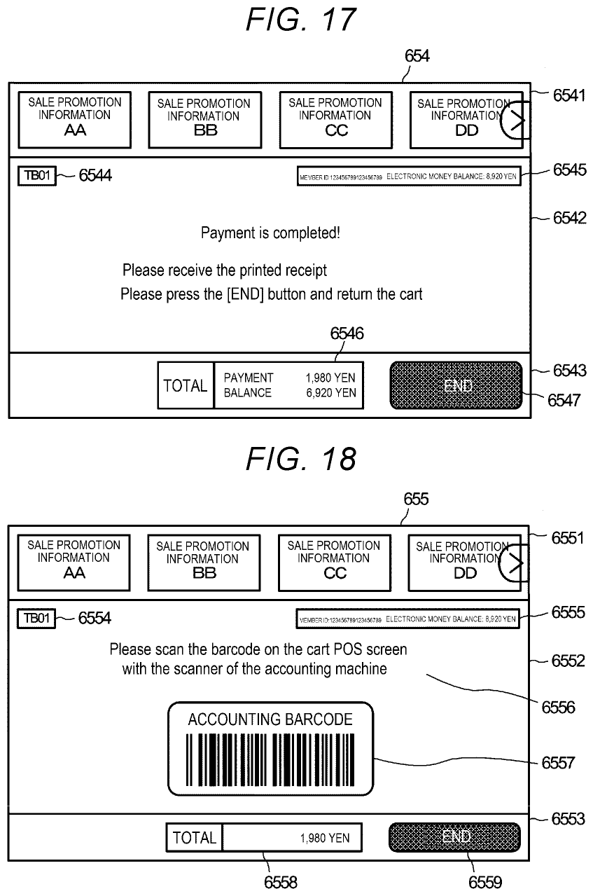

FIG. 17 is a schematic diagram illustrating an example of the display of a payment completion screen 654 in the information terminal 60. The payment completion screen 654 includes a sales promotion information display area 6541, an information presentation area 6542, and an operation area 6543. These areas are areas having the same functions as the functions of the sales promotion information display area 6511, the information presentation area 6512, and the operation area 6513 of the login screen 651.

On the payment completion screen 654, a terminal number 6544 for specifying the information terminal 60 and a member number and electronic money charge amount 6545 are displayed in the information presentation area 6542. A charge amount of the electronic money displayed in the member number and electronic money charge amount 6545 is an amount updated by payment by the electronic money. In the example illustrated in FIG. 17, in the information presentation area 6542, as information desired to be communicated to the customer, a notification of completion of payment, a notification for urging receipt of a printed receipt, and a notification for urging to return the cart C without passing an accounting lane where the accounting machine 50 is set are displayed.

In the operation area 6543, a total field 6546 and an [end] button 6547 are displayed. The total field 6546 presents an amount paid by the electronic money and a charge balance of the electronic money after the payment. The [end] button 6547 is a button for the customer to declare an end of use of the information terminal 60. According to pressing of the [end] button 6547, the processor 61 shifts to the standby state. If the [end] button 6547 is left untouched for a predetermined time such as three minutes without being pressed, the processor 61 can also shift to the standby state.

After transmitting the data for causing the information terminal 60 to display the payment completion screen to the POS server 46 in Act 4711, the processor 41 of the mobile controller 40 operating as the virtual POS 47 proceeds to Act 4712. In Act 4712, the processor 41 controls, based on the purchased commodity data stored in the purchased commodity data region 4226 of the shopping basket memory 422, the communication interface 44 to register sales data in the sales database of the store server 10. The processor 41 deletes the shopping basket memory 422. Thereafter, the processor 41 proceeds to Act 4701.

If the total amount is an amount larger than the charge amount in Act 614, the processor 61 of the information terminal 60 determines NO in Act 614 and proceeds to Act 620. In Act 620, the processor 61 causes the touch panel 65 to display a second accounting selection screen.

FIG. 18 is a schematic diagram illustrating an example of display of a second accounting selection screen 655 in the information terminal 60. The second accounting selection screen 655 includes a sales promotion information display area 6551, an information presentation area 6552, and an operation area 6553. These areas are areas having the same functions as the functions of the sales promotion information display area 6511, the information presentation area 6512, and the operation area 6513 of the login screen 651.

On the second accounting selection screen 655, as in the information presentation area 6532 of the first accounting selection screen 653, a terminal number 6554 for specifying the information terminal 60 and a member number and electronic money charge amount 6555 are displayed in the information presentation area 6552. Further, in the information presentation area 6552 of the second accounting selection screen 655, a barcode 6557 to be scanned by the accounting machine 50 is displayed together with a guidance message 6556 for guiding the customer to the accounting machine 50. The processor 61 generates the barcode 6557 based on at least the terminal number stored in the main memory 62 or the auxiliary storage device 63 and the transaction number stored in the transaction number region 624 of the main memory 62.

In the operation area 6553, a payment total amount 6558 and an [end] button 6559 are displayed. An amount presented in the payment total amount 6558 is the amount stored in the subtotal amount region 625 of the main memory 62. The [end] button 6547 is a button for the customer to declare an end of use of the information terminal 60. After scanning the barcode 6557 in the accounting machine 50 or if returning the cart C in which the information terminal 60 is provided, the customer presses the [end] button 6547. Consequently, the processor 61 shifts to the standby state. If the customer returns the cart C to a predetermined return place without pressing the [end] button 6547, the processor 61 may detect the return through position detection and shift to the standby state.

If the barcode 6557 displayed on the screen of the touch panel 65 of the information terminal 60 is scanned in the accounting machine 50, the accounting machine 50 decodes the barcode 6557 and acquires the terminal number and the transaction number. The accounting machine 50 transmits a transaction inquiry command including an accounting machine number for specifying the accounting machine 50 and the terminal number and the transaction number to the mobile controller 40 via the network NW.

If the communication interface 44 of the mobile controller 40 receives the transaction inquiry command, the processor 41 of the mobile controller 40 operating as the POS server 46 determines YES in Act 4605 and proceeds to Act 4612. In Act 4612, the processor 41 refers to the VPOS table 421 and transmits the transaction inquiry command to the virtual POS 47 corresponding to the terminal number included in the transaction inquiry command. That is, the processor 41 passes the transaction inquiry command to the VPOS program. Thereafter, the processor 41 proceeds to Act 4601.

If receiving the transaction inquiry command including the transaction number from the POS server 46, the processor 41 of the mobile controller 40 operating as the virtual POS 47 determines YES in Act 4704 and proceeds to Act 4713. In Act 4713, the processor 41 specifies, according to the transaction number, the shopping basket memory 422 corresponding to the transaction number. The processor 41 transmits, to the POS server 46, settlement data including the purchased commodity data stored in the purchased commodity data region 4226 of the shopping basket memory 422. That is, the processor 41 passes the settlement data to the POS server program. The settlement data can include the accounting machine number included in the received transaction inquiry command and the transaction number stored in the shopping basket memory 422.

If receiving the settlement data from the virtual POS 47, the processor 41 of the mobile controller 40 operating as the POS server 46 determines YES in Act 4606 and proceeds to Act 4613. In Act 4613, the processor 41 determines the accounting machine 50 at a transmission destination according to the accounting machine number included in the settlement data and controls the communication interface 44 to transmit the settlement data to the accounting machine 50. The accounting machine 50, which receives the settlement data via the network NW, is capable of executing, based on the settlement data, well-known settlement processing such as cash payment, credit card payment, and point payment. If the settlement processing ends, the accounting machine 50 transmits a settlement end notification to the mobile controller 40 via the network NW. The settlement end notification can include a terminal number of a payment target information terminal 60.

In Act 4614, the processor 41 of the mobile controller 40, which controls the transmission of the settlement data in Act 4614, waits for the settlement end notification. If the communication interface 44 receives the settlement end notification, the processor 41 determines YES in Act 4614 and proceeds to Act 4615. In Act 4615, the processor 41 refers to the VPOS table 421 and transmits the settlement end notification to the virtual POS 47 corresponding to the terminal number included in the transaction inquiry command. That is, the processor 41 passes the settlement end notification to the VPOS program. Thereafter, the processor 41 proceeds to Act 4601.

In Act 4714, the processor 41, which transmits the settlement data in Act 4713, of the mobile controller 40 operating as the virtual POS 47 waits for the settlement end notification. If receiving the settlement end notification from the POS server 46, the processor 41 determines YES in Act 4714 and proceeds to Act 4712. As explained above, in Act 4712, the processor 41 controls, based on the purchased commodity data stored in the purchased commodity data region 4226 of the shopping basket memory 422, the communication interface 44 to register sales data in the sales database of the store server 10. The processor 41 deletes the shopping basket memory 422. Thereafter, the processor 41 proceeds to Act 4701.

In this way, the processor 61 of the information terminal 60 transmits the data of the member card read by the reader 67 to the mobile controller 40, receives, from the mobile controller 40, the electronic money charge amount acquired by the mobile controller 40 from the electronic money center EMC, and stores the electronic money charge amount in the electronic money charge amount region 623 of the main memory 62. The processor 61 configures a second acquiring unit (or a second acquirer).

The processor 61 transmits the commodity code read by the scanner 66 to the mobile controller 40 to cause the shopping basket memory 422 managed by the virtual POS 47 of the mobile controller 40 to store the commodity code in the purchased commodity data region 4226 of the shopping basket memory 422. The processor 41 configures a first acquiring unit (or a first acquirer). The processor 41 of the mobile controller 40 acquires, from the commodity database 11 of the store server 10, the commodity data corresponding to the commodity code transmitted from the information terminal 60, creates purchased commodity data based on the acquired commodity data, and stores the purchased commodity data in the purchased commodity data region 4226 of the shopping basket memory 422.

If the first amount stored in the electronic money charge amount region 623 of the main memory 62 is equal to or larger than the second amount, which is the total amount of the registered commodities, stored in the subtotal amount region 625, the processor 61 of the information terminal 60 causes the touch panel 65, which is the display, to display the first accounting selection screen, which is the first screen, for determining whether settlement is performed by electronic settlement. The processor 61 configures a control unit (or a controller).

The processor 61 receives the data for displaying the payment completion screen from the mobile controller 40, causes the printer 69 to print a receipt, and causes the touch panel 65 to display the payment completion screen.

If the charge amount is smaller than the subtotal amount, the processor 61 causes the touch panel 65, which is the display, to perform the warning display indicating that the charge amount of the electronic money runs short. The processor 61 configures a message display unit (or a message display controller).

As explained above, the processor 61 compares the electronic money charge amount, which is the first amount, indicating the amount payable by the user, who is the customer, through an electronic settlement procedure and the total amount of the purchase amounts of the commodities registered as the second amount. The user can appropriately perform settlement based on a determination result of possibility of payment by the electronic settlement procedure.

In this way, by presenting action information to the customer, who is the user, the user can perform settlement with the electronic money.

The store includes the accounting area as explained above. At least one or more accounting machines 50 are disposed in the accounting area. A lane is formed as in the form of the store in the past. With the accounting machine 50, the customer is capable of performing settlement with both of the electronic money and the cash, performing settlement with the electronic money after charging the electronic money, and performing settlement using the cash, a paper note, or a discount ticket. If it is determined that the payment by the electronic settlement procedure cannot be performed, the second accounting selection screen for guiding the customer, who is the user, to the accounting machine settlement lane is displayed on the touch panel 65 of the information terminal 60. Therefore, the user can proceed to the accounting machine settlement lane and perform payment not by the electronic money without hesitating.

An electronic money charge machine is often set in the store. Therefore, the customer can perform deposit to the electronic money during shopping. If performing the deposit during the shopping, the customer presses an electronic money update key or the like displayed on the touch panel. If the electronic money update key is pressed, the POS server 46 may update information in the electronic money center EMC. If the deposit is performed, the electronic money center EMC may automatically update the charge amount by notifying the POS server 46.

If it is determined that the payment by the electronic settlement procedure can be performed, the first accounting selection screen for selecting whether payment is performed by the electronic money or payment is performed by other than the electronic money is displayed on the touch panel 65 of the information terminal 60. Accordingly, the customer, who is the user, can freely select a payment method.

If the settlement by the electronic money is selected after the display of the first accounting screen in the accounting area, the payment by the electronic money is automatically carried out. If the payment is completed, the payment completion screen is displayed on the touch panel 65. Therefore, the customer, who is the user, can confirm that the payment by the electronic money is performed. After the display of the first accounting screen, if the settlement by the electronic money is not selected, the second accounting screen is displayed on the touch panel.

During the registration of the commodity as well, possibility of the payment by the electronic settlement procedure is determined and, if it is determined that the payment cannot be performed, the warning screen for warning to that effect is displayed on the touch panel 65 only once. Therefore, since warning is not displayed many times, it is possible to prevent the customer, who is the user, from feeling annoyed because the warning display is repeated.

An exemplary embodiment is explained above, though the embodiments are not limited to what is described above.

For example, in the embodiment, the [ to accounting button] 6529 is displayed but is restricted to be operable only in the accounting area. However, the [to accounting] button] 6529 may be always operable. If the [to accounting] button 6529 is pressed, a guidance screen may be displayed to urge the user to go to the accounting area. In this case, if it is determined that the customer enters the accounting area, the first accounting screen or the second accounting screen is displayed. Alternatively, if the [to accounting] button 6529 is pressed, the first accounting screen or the second accounting screen may be displayed. If the electronic settlement is performed in the accounting area, an informing unit may be provided in the cart C to inform the store clerks and the like that the accounting ends. If the second accounting screen is displayed outside the accounting area, the customer moves to the accounting machine set in the accounting area and performs settlement.

For example, in the embodiment, the [ to accounting] button 6529 is displayed but is restricted to be operable only in the accounting area. However, the [to accounting] button 6529 may be displayed only in the accounting area.

In the embodiment, the warning is displayed once if the subtotal amount exceeds the charge amount. However, the warning is not limited to this. For example, if the charge amount becomes equal to or larger than the subtotal amount because of returned commodities or deposit to the electronic money during shopping, the warning-displayed flag stored in the warning-displayed flag region 626 of the main memory 62 may be cleared to perform commodity registration thereafter. If the subtotal amount exceeds the charge amount again, the warning display may be performed again. Rather than being temporarily displayed, the display warning may be continued to be displayed until the charge amount becomes equal to or larger than the subtotal amount by cancelling a commodity or charging the electronic money during shopping.

The warning display may be performed if the subtotal amount exceeds an amount smaller than the charge amount by a predetermined fixed amount rather than if the subtotal amount exceeds the charge amount. That is, a warning suggestion indicating that the subtotal amount is about to exceed the charge amount may be displayed rather than the warning that the subtotal amount exceeds the charge amount.

As the method of performing settlement in the accounting machine 50, the method of causing the scanner of the accounting machine 50 to read the barcode 6557 displayed on the touch panel is explained as an example. However, the method of performing settlement in the accounting machine 50 is not limited to this. For example, the processor 60 may cause the touch panel 65 of the information terminal 60 to display usable accounting machine candidates. The customer may select an accounting machine candidate to thereby determine the accounting machine 50 used for the settlement. At this time, the information terminal 60 and the accounting machine 50 only have to transmit necessary information using wireless communication. A screen for selecting one accounting machine out of the plurality of accounting machine candidates is also equivalent to the second accounting screen.

In the embodiment, it is determined whether the customer can perform settlement with the electronic money according to whether the electronic money user ID is stored in the electronic money user ID region 622 of the main memory 62 in Act 613. However, the determination is not limited to this. For example, it may be determined that the user cannot use the electronic money if a value such as NULL is stored in the amount of the electronic money in the electronic money charge amount region 623 of the main memory 62.

In the embodiment, the information terminal 60 compares the electronic money charge amount, which is the first amount, indicating the amount payable by the electronic settlement procedure and the total amount of the purchase amounts of the registered commodities, which is the second amount, and determines possibility of the payment by the electronic settlement procedure. The determination of possibility of the payment by the electronic settlement procedure may be carried out on the mobile controller 40 side. The mobile controller 40 may also create, as image data, the first accounting selection screen and the second accounting selection screen displayed on the touch panel 65 of the information terminal 60 based on the possibility determination, transmit the first accounting selection screen and the second accounting selection screen to the information terminal 60, and cause the information terminal 60 to display the first accounting selection screen and the second accounting selection screen. In this case, the mobile controller 40 only has to store the electronic money charge amount acquired from the electronic money center EMC in the shopping basket memory 422 corresponding to the electronic money charge amount.

That is, the processor 41 of the mobile controller 40 acquires, based on the data of the member card transmitted from the information terminal 60, the electronic money charge amount from the electronic money center EMC and stores the electronic money charge amount in the shopping basket memory 422. The processor 41 configures a first acquiring unit. The processor 41 compares the electronic money charge amount and the total amount of the registered commodities calculated from the commodity data stored in the purchased commodity data region 4226 of the shopping basket memory 422 and confirms whether the total amount is equal to or smaller than the charge amount. The processor 61 generates image data of the first accounting selection screen if the total amount is an amount equal to or smaller than the charge amount and generates image data of the second accounting selection screen if the total amount is an amount larger than the charge amount, transmits the image data to the information terminal 60, and causes the touch panel 65 to display the image data. The processor 41 configures a control unit. The processor 41 can also generate, as image data, the payment completion screen that the processor 41 causes the touch panel 65 of the information terminal 60 to display. The processor 41 can also generate, as image data, the warning display that the processor 41 causes the touch panel 65 of the information terminal 60 to display if the subtotal amount is larger than the charge amount. The processor 41 configures a message display unit.

If electronic money exclusive for a store that introduces the checkout system is operated, an electronic money database may be constructed in the cart POS system 1 rather than in the electronic money center EMC.

In the embodiment, the information terminal 60 attached to the cart C is illustrated. However, the information terminal 60 does not always have to be attached to the cart C. For example, a general-purpose information processing device such as a smartphone or a tablet terminal carried by a purchaser may be used as the information terminal 60. In this case, the smartphone, the tablet terminal, or the like only has to be automatically connected to the network NW of the cart POS system 1 by downloading, to the smartphone, the tablet terminal, or the like, dedicated application software (hereinafter abbreviated as application) including setting information for connecting the smartphone, the tablet terminal, or the like to the access point 70 and starting the application.

Consequently, it is possible to exchange data between the mobile controller 40 and the smartphone, the tablet terminal, or the like. If the member number is registered in the application, it is unnecessary to read the member card. To read the commodity code, a camera included in the smartphone, the tablet terminal, or the like can be used. As the printer for printing a receipt, a network printer connected to the network NW only has to be disposed in the electronic money accounting lane in the accounting area. In the case of the information terminal 60 attached to the cart C, the network printer may be used instead of providing the printer 69 for each of the carts C. In the smartphone, the tablet terminal, or the like, the receipt is not printed and may be transmitted to the smartphone, the tablet terminal, or the like as electronic data.

In the embodiment, the electronic money of a prepaid type for depositing at least a purchase price beforehand is explained as an example. However, the embodiment is also applicable to electronic money of a just pay type for withdrawing a purchase price from a predetermined account if a commodity is purchased and electronic money of a post pay type for withdrawing a purchase price from a predetermined account in a later day from a commodity purchase day. In the case of the just pay type and the post pay type, rather than the charge balance, some payable amount such as an account balance, a payable balance, or a use limit amount only has to be acquired and compared with the total amount of the registered commodities.

Further, in the embodiment, the price payment method for the member to pay a price without using the accounting machine is limited to only one type, that is, the electronic money. However, the price payment method in this case is not limited to this and may be limited to two types, that is, the electronic money and the credit card. If the price payment method is treated the same as the electronic money of the post pay type, the price payment method may be limited to one type, that is, the credit card. Alternatively, another payment method such as point payment for paying a price with a converted amount of an accumulated service point may be added.

In the embodiment, the POS server program and the VPOS program, which are the controller programs, are stored beforehand in the main memory 42 or the auxiliary storage device 43 of the mobile controller 40. Concerning this point, a controller program transferred separately from the mobile controller 40 may be written in a writable storage device included in the mobile controller 40 according to operation by the user or the like. Similarly, in the embodiment, the terminal program is stored beforehand in the main memory 62 or the auxiliary storage device 63 of the information terminal 60. However, a terminal program transferred separately from the information terminal 60 may be written in a writable storage device included in the information terminal 60 according to operation by the user or the like. The transfer of the controller program, the terminal program, and the like can be performed by being recorded in a removable recording medium or can be performed by communication via a network. A form of the recording medium may be any form if the recording medium can store programs like a CD-ROM or a memory card and can be read by a device.

Besides, the several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. A checkout system including a mobile terminal configured to acquire a commodity code for identifying a commodity, the checkout system further comprising:
a controller configured to:
acquire a first amount indicating an amount payable by an electronic settlement procedure; and
display, on a display, a first screen for determining whether settlement is to be performed through the electronic settlement procedure based on whether the first amount is equal to or greater than a second amount, which is a total amount of the commodity based on the commodity code.

2. The system according to claim 1, wherein if the first amount is less than the second amount, the controller is configured to display on the display a second screen that is a guidance screen to an accounting device.

3. The system according to claim 1, wherein the controller is configured to display the first amount, the second amount, and a key for starting settlement processing on a same screen of the display.

4. The system according to claim 1, further comprising a message controller configured to display a message on the display if the first amount is less than the second amount.

5. The system according to claim 1, wherein the controller is further configured to:
determine whether the mobile terminal is present in a predetermined area; and
display the first screen on the display if the mobile terminal is present in the predetermined area and the first amount is equal to or greater than the second amount.

6. The system according to claim 1, wherein the controller is included in a carrier that carries the commodity.

7. The system according to claim 1, wherein the first amount includes a balance associated with a member identifier.

8. A method, comprising:
acquiring, using a controller, a first amount indicating an amount payable by an electronic settlement procedure; and
displaying on a display, by the controller, a first screen for determining whether settlement is to be performed through the electronic settlement procedure if the first amount is equal to or greater than a second amount, which is a total amount of the commodity based on the commodity code acquired by a mobile terminal.

9. The method according to claim 8, further comprising:
if the first amount is less than the second amount, displaying a second screen, by the controller, which is a guidance screen to an accounting device, on the display.

10. The method according to claim 8, further comprising:
displaying, by the controller, the first amount and the second amount and a key for starting settlement processing on a same screen of the display.

11. The method according to claim 8, further comprising:
displaying, by the controller, a message on the display if the first amount is less than the second amount.

12. The method according to claim 8, further comprising:
determining, by the controller, whether the mobile terminal is present in a predetermined area; and
displaying, by the controller, the first screen on the display in response to determining that the mobile terminal is present in the predetermined area and the first amount is equal to or greater than the second amount.

13. The method according to claim 8, wherein the first amount includes a balance associated with a member identifier.
